(19) United States
(12) Patent Application Publication
(10) Pub. No.: US 2009/0211560 A1
(43) Pub. Date: Aug. 27, 2009

(54) Method for Operating a Tank System Comprising a Tank, and Tank System

(75) Inventors: Karl-Bernhard Lederle, Rutesheim (DE); Michael Pfeil, Schwieberdingen (DE); Silke Haag, Abstatt (DE)

Correspondence Address: MERCHANT & GOULD PC, P.O. BOX 2903, MINNEAPOLIS, MN, 55402-0903, US

(73) Assignee: ROBERT BOSCH GMBH, Stuttgart (DE)

(21) Appl. No.: 11/920,378

(22) PCT Filed: Aug. 4, 2006
(86) PCT No.: PCT/EP2006/065062

§ 371 Date: Apr. 8, 2009

(30) Foreign Application Priority Data
Sep. 2, 2005 (DE) 10 2005 041 658.6

(51) Int. Cl. F02M 33/02; B08B 7/00

(52) U.S. Cl. 123/520; 137/15.01

(57) ABSTRACT

The invention relates to a method for operating a tank system, in particularly of a motor vehicle, comprising a tank. According to the invention, said tank system has an adsorption filter for capturing the volatile substances exiting the tank. The loading of the adsorption filter suggests that the tank is being filled.

The invention concerns a procedure for operating a fuel tank system comprising a tank, especially of a motor vehicle and a fuel tank system, which has an adsorption filter for the capturing of volatile substances exiting the fuel tank to implement the procedure.

### STATE OF THE ART

In the case of motor vehicles powered by internal combustion engines, a ventilation of the fuel storage tank is absolutely required for a flawless supply of fuel. Air must be able to flow into the tank when the fuel itself is being consumed. Otherwise a vacuum would form in the fuel tank and the fuel flow would stop. The tank, however, is also ventilated in order to be able to give the contents of the tank sufficient opportunity for expansion when heated up. Moreover, when filling the tank a sufficient amount of air must be able to escape the tank, so that the fuel being filled does not immediately gush out of the filler pipe, which is provided for at the tank.

Tank ventilation devices, which have “On Board Refueling Vapor Recovering” (ORVR-functionality), are increasingly being deployed. In such devices, volatile, respectively excess, fuel vapor or gas is not dispensed into the atmosphere but by way of a ventilation line with a large cross section into a device to store the exiting hydrocarbons, for example an activated carbon filter. Updated fuel tank systems known from the state of the art are designed in such a manner that the vacuum necessary for refueling occurs when the tank is being filled. The fuel vapor is stored in the device for storage of the exiting hydrocarbons, for example in the activated carbon filter; and when the motor vehicle is being driven, it is delivered to an intake pipe of the internal combustion engine via an electromagnetic fuel tank ventilation valve. Thus, it is supplied to the combustion. In this way an emission of environmentally toxic fuel vapors from the tank into the surrounding atmosphere can be prevented as much as possible, and at the same time the vapors delivered to the internal combustion engine can themselves be deployed as fuel, whereby the fuel consumption is also reduced.

In order to comply with the emission standards in the United States of America, motor vehicles with gasoline engines must be equipped with a device for the On-Board-Diagnosis of the fuel system. With this device leakages with a diameter greater than or equal to 0.5 mm are supposed to be detected. In order to make sure that a filler pipe cap opened to permit fueling is not detected as a leakage error and entered as such into an error memory, a mileage debouncing occurs with fueling recognition concerning the increase in the fill level of the fuel tank. Such a procedure is, for example, known from the German patent DE 101 39 619 A1. In order to make a low-emission operation of a fuel tank system possible with means as simple and as cost effective as possible, also particularly when fueling the vehicle, the tank fill level is acquired during this procedure when the fuel tank is being filled; and when a maximum tank fuel level is present, a cut-off valve is actuated to close. In so doing, a leakage of volatile substances is supposed to be avoided. For this purpose an evaluation of a tank fill level signal is, however, required, which is produced by a fill level transmitter. Now due to the government emissions standards, all components, which are used for a required diagnosis, must likewise be monitored for their operational efficiency. Hence, a fill level transmitter of this kind must also be monitored.

It is thus the task of the invention to put forth a procedure for operating a fuel tank system comprising a tank, which recognizes a fueling of the tank without evaluation of a tank fill level signal. The fueling of the tank is then, for example, taken into account by the device for the On-Board-Diagnosis of the fuel system.

### ADVANTAGES OF THE INVENTION

This task is thereby solved in the procedure for operating a fuel tank system comprising a tank especially of a motor vehicle of the kind described at the beginning of the application, in that the loading of the adsorption filter suggests that the tank is being filled.

The task is additionally solved by a fuel tank system comprising a tank especially of a motor vehicle and by an adsorption filter for capturing the volatile substances exiting the tank, whereby provision is made for a control unit to acquire the signals, which characterize the loading of the adsorption filter and due to the loading ascertain that the tank is being filled.

It is the fundamental idea of the invention to conclude that the fuel tank is being filled from the change in the loading of the adsorption filter during fueling of the tank, in order that the use of high precision tank fill level transmitters and the evaluation of the tank fill level signals can be avoided; or provided that the tank fill level transmitters exist, their use may be enhanced or, for example, their efficiency may be checked.

Additional advantages and characteristics of the invention are the subject matter of the sub-claims referring back to claim 1.

In this way the loading is advantageously determined and stored by the purging and adapting of the loading during every driving cycle. A filling of the tank is then simultaneously suggested, if the loading after a shutdown of the vehicle is greater than the loading before the shutdown of the vehicle by a specifiable value.

In order to determine the loading, the factors distinguishing the operating state of the internal combustion engine of the vehicle and/or the factors distinguishing the outside influences are taken into account, for example the useful life or an elevation change or the outside temperature or the humidity of the air, the air pressure etc. In this manner, the accuracy of the determination of the loading can be increased.

Additional advantages and characteristics of the invention are the subject matter of the following description as well as of the graphic depiction of an example of embodiment of the invention.

### DRAWINGS

The following are shown in the drawing:

FIG. 1 schematically a fuel tank system according to the invention in schematic depiction and

FIG. 2 a procedure according to the invention for operating the fuel tank system depicted in FIG. 1 using a flow diagram.

### DESCRIPTION OF THE EXAMPLES OF EMBODIMENT

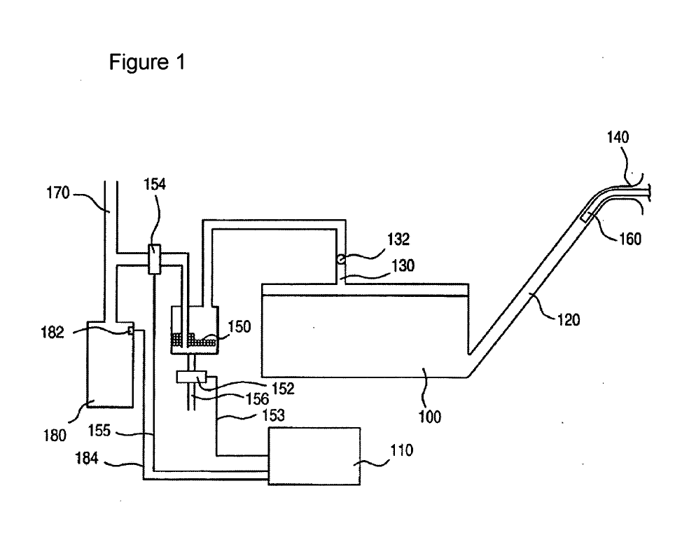

A fuel tank system shown in FIG. 1 has a fuel tank 100, from which a filler pipe 120 protrudes. Fuel is filled into the tank 100 with the help of the aforementioned filler pipe 120. A fuel pump nozzle 160 is indicated in the area of a filler neck 140 formed at the upper end of the filler pipe 120. In the upper area of the fuel tank 100, a ventilation line 130 projects out of the same and empties into a device for the adsorption and storage of fuels, for example an activated carbon filter. Vaporized fuel is delivered in this way to the activated carbon filter 150. Especially when filling the fuel tank 100, fuel vapors in the formative stage are carried to the activated carbon filter 150 and captured there.

When the motor vehicle is being driven, the activated carbon filter 150 is intermittently regenerated from the fuel vapor adsorbed up to that point by means of a fuel tank ventilation valve 154, which is activated by a control unit 110 via a control lead 155. This fuel ventilation valve 154 allows the fuel vapor to be led into an intake system 170 of an internal combustion engine 180. In this instance, a check valve 152 is switched open via a control lead 153, so that air flows by way of an aeration line 156 into the activated carbon filter 150.

Preferably another mechanically designed Rollover valve (ROV) 132 is disposed additionally in the ventilation line 130 somewhat above the fuel tank 100 for safety reasons. This serves to close the ventilation line 130 in the case of a rollover of the vehicle, in order that an unimpeded discharge of fuel into the adsorption filter is thereby prevented. It is furthermore to be noted that the check valve 152 can also be actuated to the closed position for an inherently known leak tightness test of the fuel tank, which, for example, proceeds from the American patent U.S. Pat. No. 5,890,474 and is described therein in detail.

Additionally sensors 182 are denoted on the internal combustion engine 180, which stand for the acquisition of control factors of the internal combustion engine 180, for example the fuel-air-mixture and the like; and these control factors are likewise supplied to the control unit 110 via a signal line 184.

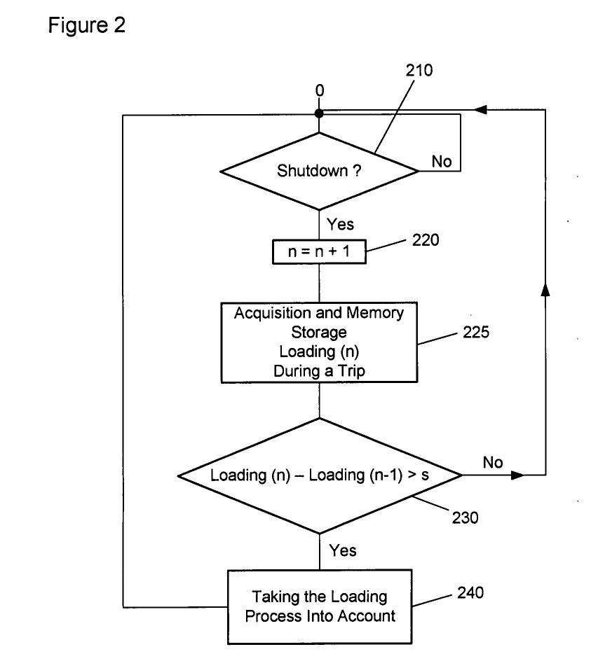

The acquisition of a filling of the fuel tank is now subsequently described in detail in connection with FIG. 2.

A test is initially made in a step 210 to see if a shutdown of the motor vehicle is present. If this is the case, a control variable is increased by 1 in step 220: n=n+1.

The loading of the activated charcoal filter 150 is then acquired and stored in step 225 during a trip following the shutdown. This results from the fact that the valves 152, respectively 154, are actuated to open by the control unit 110 via the control leads 153, respectively 155, so that the loading of the activated carbon filter 150 is delivered to the intake pipe 170 of the internal combustion engine 180. The adapted loading of the adsorption filter 150 is ascertained and stored by the sensors 182, whereby especially here factors of the engine management system of the internal combustion engine 180, such as engine rotational speed and the like, which are known, as well as outside influences, such as the elevation above sea level, the outside temperature and the like are taken into account in order to increase the precision of the determination of the loading.

Hence, in step 230 the difference is determined and compared with a threshold value S between the loading determined in the above manner and the loading respectively ascertained during a trip (n−1) before the shutdown of the motor vehicle. If the difference of the loading of the trip n after the shutdown reduced by the loading of the trip (n−1) before the shutdown is greater than the threshold value S, the conclusion is drawn that the tank is being filled. This fueling is then taken into account (step 240). If this is not the case, the system returns back to the state before step 210, in which it is ascertained, if a shutdown is taking place.

The advantage of the described procedure is that tank fill level transmitters are not required to ascertain a filling of the tank. Thereby the diagnosis required by law of these transmitters can be avoided. The procedure provides this ascertainment without additional hardware and can simply and cost effectively be implemented in the engine control unit 110. The procedure especially has no influence at all on the engine's smoothness or the exhaust gas emissions because the regeneration of the adsorption filter 150 is conducted anyway from time to time in this kind of an internal combustion engine. Furthermore, the procedure also has no affect on the activity of other diagnostic operations.

It goes without saying that the procedure can alternatively be used to improve the diagnosis of an existing tank fill level transmitter or, for example, to perform a check on it.

The procedure described above can also be deployed during a leak test of the fuel tank. During a leak test, in which leakages with a diameter greater than or equal to 0.5 mm are supposed to be ascertained by the introduction of an overpressure (positive pressure) or a negative pressure into the fuel tank system. It is, of course, not be ruled out that the fuel tank is already open because a filling of the tank is supposed to be immediately initiated. In this case, a detected leakage is considered to be suspicious and a test is made in the ensuing course of the trip to see if the tank was filled. If this is the case, the result is discarded. If, however, this is not the case, a leak is concluded to exist after a specifiable, applicable travel distance or time; and an error is registered in an error memory.

1. A method for operating a tank system of a motor vehicle having a tank, which has an adsorption filter for capturing volatile substances exiting the tank, the method comprising determining the tank is being filled by determining loading of the adsorption filter.

2. A method according to claim 1, wherein loading is determined by means of rinsing and adaptation of the loading during every trip of the motor vehicle.

3. A method according to claim 1, wherein a filling of the tank is determined, if a loading during a trip and a shutdown of the motor vehicle is greater than the loading during a trip before the shutdown of the motor vehicle by a specifiable value.

4. A method according to claim 1, wherein variables characterizing an operating state of an internal combustion engine of the motor vehicle or variables characterizing environmental factors are taken into account in determining the loading.

5. A method according to claim 4, wherein an engine rotational speed or a fuel to air ratio are the variables characterizing the operating state.

6. A method according to claim 4, wherein elevation above sea level, temperature, humidity, or air pressure are the variables characterizing the environmental factors.

7. A tank system of a motor vehicle comprising a tank, an adsorption filter for capturing volatile substances exiting the tank, a control unit to acquire signals, which characterize loading of the adsorption filter and determine a filling of the tank from the loading.
